(19) United States
(12) Patent Application Publication
(10) Pub. No.: US 2007/0218876 A1
(43) Pub. Date: Sep. 20, 2007

(54) Service System And Mobile Communication Terminal For Free Using Of Data Communication

(76) Inventor: Jong-do Park, Daegu (KR)

Correspondence Address: CANTOR COLBURN, LLP, 55 GRIFFIN ROAD SOUTH, BLOOMFIELD, CT, 06002, US

(21) Appl. No.: 10/578,598

(22) PCT Filed: Nov. 4, 2004
(86) PCT No.: PCT/KR04/02840

§ 371 Date: Apr. 26, 2007

(30) Foreign Application Priority Data
Nov. 6, 2003 (KR) 10-2003-0078299
Jan. 20, 2004 (KR) 10-2004-0004344

(51) Int. Cl. H04Q 7/22

(52) U.S. Cl. 455/412.1

(57) ABSTRACT

Disclosed herein are an advertisement-linked free message provision system and a mobile communication terminal. In the advertisement-linked free message provision system, a customer receives a free message content linked to an advertisement of an advertiser, or affiliated store, through a customer terminal and propagates the advertisement of the advertiser and free messages to other parties, typically his/her acquaintances, using the received free message content. Therefor, the customer can send messages free of charge, and the advertiser, or affiliated store, cab maximize advertising effects and thus gain an opportunity to win over new customers, which leads to an advanced mobile target marketing advertising activity over an existing one-to-one target marketing advertising activity.

### TECHNICAL FIELD

The present invention relates to a system for providing free messages linked to advertisements, and more particularly to an advertisement-linked free message provision system wherein a mobile telephone user sends a message to a mobile telephone of another party along with an advertisement and is then allowed to use a message service free of charge as a reward for the advertisement sending.

### BACKGROUND ART

With the rapid advance of the information communication industry, recently, mobile telephones have had rapidly improved functions compared to previous ones, thereby enabling mobile telephone subscribers to send and receive text messages or multimedia messages to/from one another using a short message service (SMS) or multimedia message service (MMS) through their mobile telephones, departing from a traditional concept of just communicating over the mobile telephones.

However, in order to use the SMS or MMS, the mobile telephone subscribers have to separately defray text or multimedia data usage fees, in addition to call fees. For this reason, customers have desires to use the SMS or MMS, but cannot practically use the SMS or MMS to the full due to their economic burdens.

### DISCLOSURE OF THE INVENTION

Therefore, the present invention has been made in view of the above problems, and it is an object of the present invention to provide an advertisement-linked free message provision system wherein each affiliated store distributes free message usage certificates linked to an advertisement thereof to customers for the purpose of advertising itself, thereby reducing the customers' burdens of text data usage fees to enable the customers to use a message service without a heavy burden.

It is another object of the present invention to provide an advertisement-linked free message provision system which is capable of maximizing advertising effects through a free message service linked to advertisements of affiliated stores.

In accordance with an aspect of the present invention, the above and other objects can be accomplished by the provision of an advertisement-linked free message provision system in which a message sender sends an advertisement-linked free message to a message recipient, comprising a free message management server including: a free message usage certificate management database for storing information regarding sales of free message usage certificates from at least one communication company, sold to one or more affiliated stores; an advertisement database for storing advertisements; a free message use request information receiver for receiving free message use request information containing a telephone number of a specific customer acquiring at least one of the free message usage certificates and affiliated store identification information from a specific one of one or more affiliated store terminals held respectively by the affiliated stores; an authentication processor for searching the sale information stored in the free message usage certificate management database for sale information corresponding to the affiliated store identification information to determine whether the corresponding sale information is present in the stored sale information, and performing an authentication process based on the determination result; and a free message manager for, if the free message use request information is authenticated by the authentication processor, allocating an advertisement-linked free message content to the specific customer and transmitting free message content allocation information containing the telephone number of the specific customer to a communication company server managed by the communication company so that the communication company server can deduct the amount of money corresponding to use of the allocated free message content from a text data usage fee to be charged to the customer's telephone number.

In accordance with another aspect of the present invention, there is provided an advertisement-linked free message provision system comprising a free message management server including: a free message usage certificate management database for storing information regarding sales of free message usage certificates from at least one communication company, sold to one or more affiliated stores; an advertisement database for storing respective advertisements of the affiliated stores; a content manager for creating free message contents linked respectively to the advertisements of the affiliated stores stored in the advertisement database and distributing the created advertisement-linked free message contents; and a free message manager for receiving information regarding use of a specific one of the distributed advertisement-linked free message contents through a random customer terminal and, on the basis of the received information, requesting the communication company to deduct the amount of money corresponding to the use of the specific advertisement-linked free message content from a text data usage fee to be charged to a telephone number of the customer terminal.

In accordance with yet another aspect of the present invention, there is provided a mobile communication terminal comprising: a free message content receiver for receiving a free message content linked to an advertisement of a specific affiliated store from a free message management server or an affiliated store terminal held by the specific affiliated store and storing the received free message content in a free message content database; a free message manager for executing the advertisement-linked free message content stored in the free message content database, receiving message contents and a telephone number of a message recipient inputted from a user, and sending a free message linked to the advertisement of the specific affiliated store and containing the received contents to the message recipient's telephone number; and a free message content use information transmitter for transmitting information regarding use of the free message content through the free message manager by the user to the free message management server.

In a feature of the present invention, each affiliated store distributes free message usage certificates linked to an advertisement thereof to customers for the purpose of advertising itself, thereby reducing the customers' burdens of text data usage fees. Further, each affiliated store can maximize advertising effects through a free message service linked to the advertisement thereof.

In other words, a customer receives a free message content linked to an advertisement of an advertiser, or affiliated store, through a customer terminal and propagates the advertisement of the advertiser and free messages to other parties, typically his/her acquaintances, using the received free message content. Therefore, the customer can send messages free of charge, and the advertiser, or affiliated store, can maximize advertising effects and thus gain an opportunity to win over new customers, which leads to an advanced mobile target marketing advertising activity over an existing one-to-one target marketing advertising activity.

### DESCRIPTION OF THE DRAWINGS

The above and other objects, features and other advantages of the present invention will be more clearly understood from the following detailed description taken in conjunction with the accompanying drawings, in which:

FIG. 1 is a schematic view of an advertisement-linked free message provision system according to the present invention;

FIG. 2 is a block diagram showing an embodiment of the advertisement-linked free message provision system according to the present invention;

FIG. 3 is a flow chart illustrating the operation of the embodiment of FIG. 2;

FIG. 4 is a block diagram showing another embodiment of the advertisement-linked free message provision system according to the present invention;

FIG. 5 is a flow chart illustrating the operation of the embodiment of FIG. 4;

FIG. 6 is a block diagram showing an embodiment of an advertisement-linked free message content management module that can be run in a customer terminal;

FIG. 7 is a flow chart illustrating the operation of the advertisement-linked free message content management module of FIG. 6; and

FIGS. 8 to 11 are views showing exemplary screens of an advertisement-linked free message content which is executed in the customer terminal.

### BEST MODE

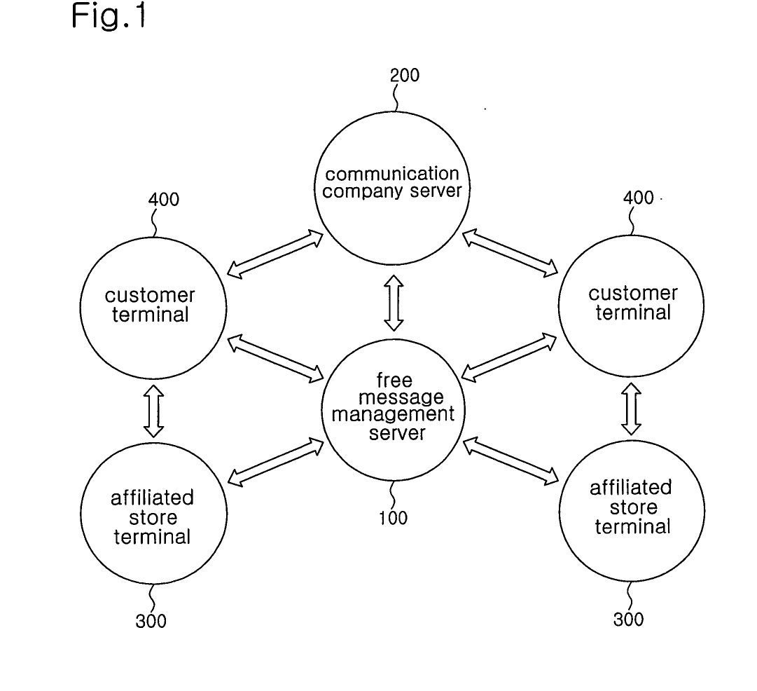

FIG. 1 is a schematic view of an advertisement-linked free message provision system according to the present invention.

With reference to FIG. 1, the advertisement-linked free message provision system according to the present invention comprises a free message management server 100, a communication company server 200, a plurality of affiliated store terminals 300, and a plurality of customer terminals 400.

In the advertisement-linked free message provision system according to the present invention, the free message management server 100 is adapted to receive and store advertisements of respective advertisers, or affiliated stores, from the corresponding affiliated store terminals 300, create free message contents linked respectively to the advertisements of the affiliated stores, distribute the created free message contents to customers, and request the communication company server 200 to deduct the amount of money corresponding to use of any one of the distributed free message contents by each of the customers through a corresponding one of the customer terminals 400 from a text data usage fee to be charged to the corresponding customer terminal. Therefore, the customers can send messages free of charge, and the advertisers, or affiliated stores, can maximize advertising effects and gain an opportunity to win over new customers.

Note that a detailed description of the present invention will be made on the assumption that the customer terminal is a mobile communication terminal such as a mobile telephone or personal digital assistant (PDA).

A detailed description will hereinafter be given of the configuration and operation of the advertisement-linked free message provision system according to the present invention.

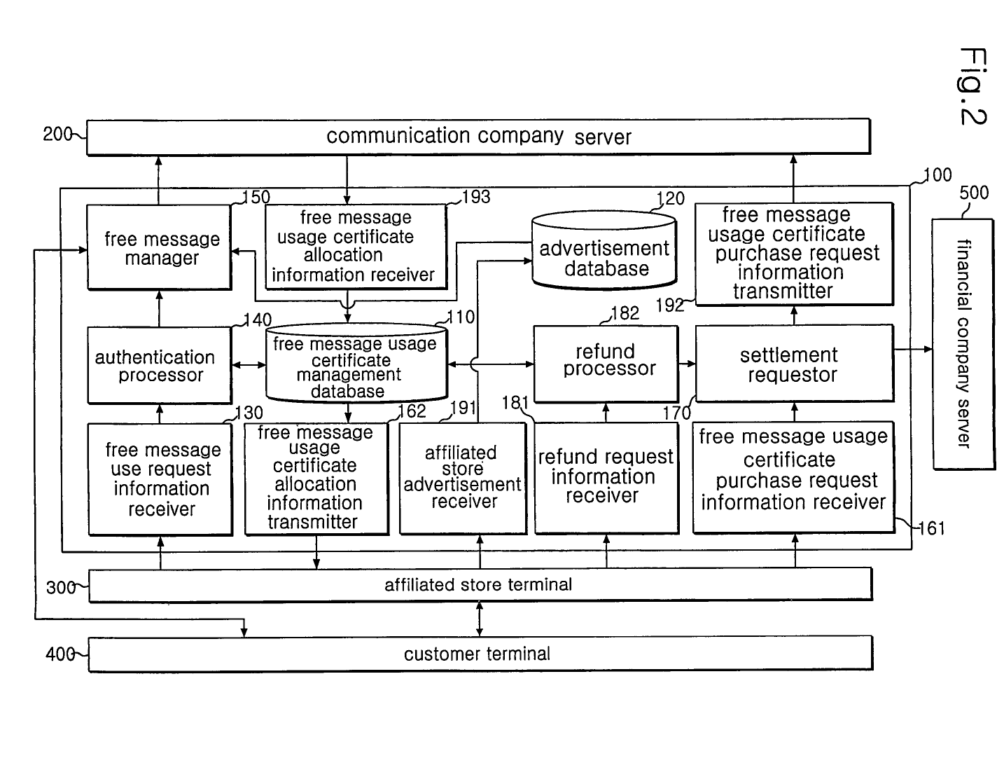

FIG. 2 is a block diagram showing an embodiment of the advertisement-linked free message provision system according to the present invention.

In the present embodiment, the advertisement-linked free message provision system is adapted to provide free message usage certificates linked to an advertisement of each advertiser, or affiliated store, to selected customers of each affiliated store through each affiliated store. A free message management server collects and sums up the demands for free message usage certificates from advertisers, or affiliated stores, purchases the summed-up number of free message usage certificates from at least one communication company or issues them by itself in concert with the communication company, and sells and distributes the purchased or issued free message usage certificates to the affiliated stores. The affiliated stores provide the distributed free message usage certificates to customers.

The free message usage certificates are material/immaterial vouchers though which the affiliated stores grant the customers the right to use messages free of charge, for the purpose of advertising themselves. The free message usage certificates can be provided in various forms such as offline coupons or online electronic barcodes of a digital data format. That is, the free message usage certificates can be provided in various ways irrespective of form. A manager of the free message management server can online/offline sell the free message usage certificates to the affiliated stores.

In the present invention, the term “free message service” means a comprehensive message sending/receiving service including either a short message service (SMS) or multimedia message service (MMS), and the term “text data usage fee” means a fee for use of the SMS or MMS to be charged to a customer.

With reference to FIG. 2, the advertisement-linked free message provision system comprises a free message management server 100, at least one communication company server 200, one or more affiliated store terminals 300, at least one customer terminal 400 and at least one financial company server 500.

The free message management server 100 is managed directly by a communication company or separately by a different company in concert with the communication company to purchase free message usage certificates from the communication company or issue them by itself, sell the purchased or issued free message usage certificates to affiliated stores, store information regarding the sales of the free message usage certificates, and perform a customer relationship management process based on the sale information.

The free message management server 100 is adapted to sell free message usage certificates in the following two schemes.

The first scheme is a cooperative purchase scheme wherein the free message management server 100 collects and sums up the demands for free message usage certificates from the affiliated stores, makes a cooperative purchase for the summed-up number of free message usage certificates from the communication company or issues them by itself, and distributes the purchased or issued free message usage certificates to the affiliated stores, and the stores provide the distributed certificates to customers.

The second scheme is a resale scheme wherein the free message management server 100 purchases free message usage certificates from the communication company in large quantities or issues them by itself, and resells the purchased or issued free message usage certificates to the affiliated stores, and the stores provide the resold certificates to customers.

Note that the above-mentioned free message usage certificate sale schemes are just matters of sale procedure and have no effect on the configuration of the advertisement-linked free message provision system according to the present embodiment.

In detail, the free message management server 100 includes a free message usage certificate management database 110, an advertisement database 120, a free message use request information receiver 130, an authentication processor 140, and a free message manager 150.

The free message usage certificate management database 110 is adapted to store information regarding the sales of free message usage certificates from at least one communication company, sold to one or more affiliated stores.

The free message usage certificate sale information contains respective identification information of the affiliated stores, the amount or number of free message usage certificates purchased from each communication company by each of the affiliated stores, the amount or number of the purchased free message usage certificates in stock, etc. The customer relationship management process can be performed on the basis of the sale information.

The advertisement database 120 is adapted to store respective advertisements of the affiliated stores.

That is, the advertisement database 120 stores advertisements for advertising the corresponding affiliated stores, received therefrom, on an affiliated store-by-affiliated store basis. At this time, at least one advertisement can be stored for each affiliated store.

The free message use request information receiver 130 is adapted to receive, from a specific one of the affiliated store terminals 300, free message use request information containing a telephone number of a specific customer acquiring a free message usage certificate and affiliated store identification information.

Each affiliated store distributes a free message usage certificate linked to an advertisement thereof to a customer and, using a corresponding one of the affiliated store terminals 300, inputs free message use request information with a telephone number of the customer acquiring the free message usage certificate to transmit it to the free message management server 100. At this time, affiliated store identification information, such as a unique number set in the corresponding affiliated store terminal 300, is transmitted to the free message management server 100 together with the free message use request information.

At this time, each affiliated store may further include an advertisement thereof in the free message use request information and transmit the resulting free message use request information to the free message management server 100. However, it is preferable that an advertisement of each affiliated store is stored in the advertisement database in advance in cooperation between each affiliated store and the free message management server 100, as stated previously.

Alternatively, the free message use request information containing the telephone number of the specific customer acquiring the free message usage certificate may be inputted and transmitted to the free message management server 100 using the customer terminal 400, not the specific affiliated store terminal 300.

Each of the affiliated store terminals 300 may be, for example, a dedicated terminal or personal computer installed in the corresponding affiliated store, or a mobile telephone or PDA of the corresponding affiliated store.

The authentication processor 140 is adapted to search the sale information stored in the free message usage certificate management database 110 for sale information corresponding to the affiliated store identification information to determine whether the corresponding sale information is present in the stored sale information, and perform an authentication process based on the determination result.

The sale information stored in the free message usage certificate management database 110 contains respective identification information of the affiliated stores, the amount or number of free message usage certificates purchased from each communication company by each of the affiliated stores, the amount or number of the purchased free message usage certificates in stock, etc. The authentication processor 140 searches the stored sale information for the sale information corresponding to the affiliated store identification information transmitted from the specific affiliated store terminal 300, received by the free message use request information receiver 130, to determine whether the corresponding sale information is present in the stored sale information, and performs the authentication process based on the determination result. In the authentication process, the authentication processor 140 outputs authentication information if the corresponding sale information is present in the stored sale information, and authentication failure information if the corresponding sale information is not present in the stored sale information.

This technique for searching the database and performing the authentication process based on the search result is well known to those skilled in the art and a detailed description thereof will thus be omitted.

The free message manager 150 is adapted to, if the free message use request information is authenticated by the authentication processor 140, allocate the specific customer a free message content linked to an advertisement of a specific affiliated store holding the specific affiliated store terminal 300 and transmit free message content allocation information containing the telephone number of the specific customer to the communication company server 200 so that the server 200 can deduct the amount of money corresponding to use of the allocated free message content from a text data usage fee to be charged to the customer's telephone number.

That is, the free message manager 150 allocates the free message content linked to the advertisement of the specific affiliated store to the specific customer's telephone number authenticated by the authentication processor 140, and the specific customer sends a message and the advertisement of the specific affiliated store to a mobile telephone of another party through the customer terminal 400 free of charge using the allocated advertisement-linked free message content.

As stated above, the free message manager 150 transmits the free message content allocation information containing the telephone number of the specific customer to the communication company server 200.

Then, a billing server of the communication company server 200 receives the free message content allocation information transmitted from the free message manager 150, deducts the amount of money corresponding to the use of the allocated free message content from a text data usage fee in communication fees of the next term to be charged to the specific customer's telephone number on the basis of the received free message content allocation information, and issues the resulting communication fee bill to the customer. As a result, the customer can benefit from an advertisement-linked free message service using the free message usage certificate, resulting in a tangible effect of reducing the customer's burden of communication cost, and the specific affiliated store has the advantage of advertising itself.

On the other hand, provided that a text data usage fee resulting from use of a text message service by the specific customer acquiring the free message usage certificate is less than the amount of money corresponding to the use of the allocated free message content, the billing server of the communication company server 200 may instead deduct the remaining amount of money from a call fee in the customer's communication fees.

Techniques related to the billing process of the communication company server 200 are well known to those skilled in the art and a detailed description thereof will thus be omitted.

In the present embodiment, the free message management server 100 of the advertisement-linked free message provision system further includes a free message usage certificate purchase request information receiver 161 and a free message usage certificate allocation information transmitter 162.

The free message usage certificate purchase request information receiver 161 is adapted to receive free message usage certificate purchase request information from each of the affiliated store terminals 300.

Each affiliated store desiring to provide free message usage certificates linked to an advertisement thereof to customers requests the purchase of free message usage certificates of an amount corresponding to its demand from the free message management server 100 online/offline. The offline purchase request can be made based on a contract, and the online purchase request can be made through the fact that each of the affiliated store terminals 300 transmits the free message usage certificate purchase request information to the free message usage certificate purchase request information receiver 161.

The free message usage certificate allocation information transmitter 162 is adapted to transmit free message usage certificate allocation information based on the free message usage certificate purchase request information received by the free message usage certificate purchase request information receiver 161 to each of the affiliated store terminals 300.

Upon receiving the free message usage certificate purchase request information transmitted from each of the affiliated store terminals 300, the free message management server 100 transmits the free message usage certificate allocation information based on the received information to the corresponding affiliated store terminal 300 to sell free message usage certificates to the corresponding affiliated store. The free message management server 100 then stores information regarding the sales of the sold free message usage certificates in the free message usage certificate management database 110.

In this embodiment, the free message management server 100 of the advertisement-linked free message provision system further includes a settlement requestor 170.

The settlement requester 170 is adapted to transmit settlement request information to the financial company server 500 to request it to settle the affiliated stores' accounts for the prices for purchases of the free message usage certificates, respectively, and then receive results of the settlements from the financial company server 500.

In other words, upon receiving the free message usage certificate purchase request information transmitted from each of the affiliated store terminals 300, the free message management server 100 transmits a screen interface associated with settlement of a purchasing price corresponding to the received free message usage certificate purchase request information to the corresponding affiliated store terminal 300 to display it thereon. Thereafter, the settlement requester 170 transmits settlement information inputted from the corresponding affiliated store terminal 300 to the financial company server 500 to request it to settle the corresponding affiliated store's account for the purchasing price, and then receives a result of the settlement from the financial company server 500.

This settlement process can be performed through an online account transfer or credit card settlement, and the settlement-related techniques are well known to those skilled in the art and a detailed description thereof will thus be omitted.

In this embodiment, the free message management server 100 of the advertisement-linked free message provision system further includes a refund request information receiver 181 and a refund processor 182.

The refund request information receiver 181 is adapted to receive refund request information containing a returned amount of the free message usage certificates and the affiliated store identification information from the specific affiliated store terminal 300.

In the case where some of the free message usage certificates purchased from the free message management server 100 remain after being distributed to customers, each affiliated store can request a refund of the remaining free message usage certificates online/offline. For the online refund request, the refund request information transmitted from the specific affiliated store terminal 300 is received by the refund request information receiver 181.

The refund processor 182 is adapted to, if the authentication processor 140 searches the sale information stored in the free message usage certificate management database 110 for the sale information corresponding to the affiliated store identification information to determine whether the corresponding sale information is present in the stored sale information, and authenticates the specific affiliated store as a result of the determination, request the financial company server 500 through the settlement requester 170 to pay the specific affiliated store a refund of the returned free message usage certificate amount contained in the refund request information received by the refund request information receiver 181, and update the free message usage certificate management database 110 on the basis of the refund request information.

That is, in response to the refund request information transmitted from the specific affiliated store terminal 300 and received by the refund request information receiver 181, the refund processor 182 performs a refund process for the returned free message usage certificate amount after authentication by the authentication processor 140. The authentication processor 140 searches the sale information stored in the free message usage certificate management database 110 for the sale information corresponding to the affiliated store identification information to determine whether the corresponding sale information is present in the stored sale information, and performs the authentication process based on the determination result. If the authentication processor 140 authenticates the specific affiliated store as a result of the determination, the refund processor 182 requests the financial company server 500 through the settlement requester 170 to pay the specific affiliated store a refund of the returned free message usage certificate amount, and updates the free message usage certificate management database 110 on the basis of the refund request information.

On the other hand, it is preferable that a refund request and process between the free message management server 100 and the communication company is carried out offline with respect to free message usage certificates purchased from the communication company, and a description thereof will be omitted.

In this embodiment, the free message management server 100 of the advertisement-linked free message provision system further includes an affiliated store advertisement receiver 191.

The affiliated store advertisement receiver 191 is adapted to receive an advertisement of each affiliated store from a corresponding one of the affiliated store terminals 300 and store the received advertisement in the advertisement database 120.

In other words, each affiliated store desiring to advertise itself using free message usage certificates has to register an advertisement thereof in the free message management server 100. It is preferable that each affiliated store transmits the advertisement thereof online to the free message management server 100 through the corresponding affiliated store terminal 300. The free message management server 100 receives the advertisement of each affiliated store through the affiliated store advertisement receiver 191 and stores it in the advertisement database 120 on an affiliated store-by-affiliated store basis.

Meanwhile, in the present embodiment, the free message manager 150 of the advertisement-linked free message provision system may check whether the specific customer has sent all messages of a number set in the free message content linked to the advertisement of the specific affiliated store, allocated thereto, and request the communication company server 200 to deduct the amount of money corresponding to the use of the allocated free message content from a text data usage fee to be charged to the customer's telephone number, if the customer has sent all the set number of messages.

In this case, the specific customer is forced to use a free message usage certificate linked to the advertisement of the specific affiliated store. For example, assume that the specific affiliated store has distributed, to the specific customer, a free message usage certificate allowing sending of one hundred messages. In this case, only when the customer has sent all one hundred messages linked to the affiliated store's advertisement to message recipients, the communication company server 200 deducts a message usage fee corresponding to the hundred messages from the customer's text data usage fee. Unless the customer has sent all the hundred messages linked to the affiliated store's advertisement, the communication company server 200 performs no deduction based on the message sending. Hence, the customer is forced to use free messages linked to the affiliated store's advertisement, thereby increasing advertising effects still more.

In the present embodiment, the free message management server 100 of the advertisement-linked free message provision system further includes a free message usage certificate purchase request information transmitter 192 and a free message usage certificate allocation information receiver 193.

The free message usage certificate purchase request information transmitter 192 is adapted to transmit free message usage certificate purchase request information to the communication company server 200.

In other words, in the case where the communication company issues free message usage certificates, the free message management server 100 requests the purchase of the free message usage certificates from the communication company online/offline in the resale scheme or cooperative purchase scheme. The offline purchase request can be made based on a contract, and the online purchase request can be made through the fact that the free message usage certificate purchase request information transmitter 192 transmits the free message usage certificate purchase request information to the communication company server 200.

The free message usage certificate allocation information receiver 193 is adapted to receive free message usage certificate allocation information based on the free message usage certificate purchase request information from the communication company server 200.

That is, if the free message management server 100 transmits the free message usage certificate purchase request information to the communication company server 200 through the free message usage certificate purchase request information transmitter 192, then the communication company server 200 receives the transmitted free message usage certificate purchase request information and transmits the free message usage certificate allocation information based on the received information to the free message management server 100. Then, the free message usage certificate allocation information receiver 193 receives the free message usage certificate allocation information transmitted from the communication company server 200.

The communication company server 200 is adapted to allocate free message usage certificates to the free message management server 100 and, on the basis of the free message content allocation information from the server 100, deduct the amount of money corresponding to the use of the allocated free message content linked to the advertisement of the specific affiliated store from a text data usage fee to be charged to the specific customer's telephone number contained in the allocation information.

On the other hand, provided that a text data usage fee resulting from use of a pay text message service by the specific customer acquiring the free message usage certificate is less than the amount of money corresponding to the use of the allocated free message content, the billing server of the communication company server 200 may instead deduct the remaining amount of money from a call fee in the customer's communication fees.

Each of the affiliated store terminals 300 is adapted to transmit free message use request information with a customer's telephone number and affiliated store identification information for authentication to the free message management server 100.

Each of the affiliated store terminals 300 is also adapted to transmit free message usage certificate purchase request information to the free message management server 100 and receive free message usage certificate allocation information based on the free message usage certificate purchase request information from the free message management server 100.

The customer terminal 400 is adapted to receive the advertisement-linked free message content allocated from the free message management server 100 and use a short message service (SMS) or multimedia message service (MMS) free of charge using the received free message content.

That is, if the specific customer receives the advertisement-linked free message content allocated from the free message management server 100 through the customer terminal 400, he/she executes the received free message content in the customer terminal 400 to send a free message linked to the advertisement of the specific affiliated store to a mobile telephone of another party. Accordingly, the customer uses the message service free of charge as a reward for the advertisement sending.

The customer terminal 400 is preferably a mobile communication terminal such as a mobile telephone or PDA. The advertisement of the specific affiliated store preferably includes at least one of a video, image and text.

An advertisement-linked free message content management module is implemented in the form of software that can be run in the customer terminal 400, and a detailed description thereof will be given later.

The financial company server 500 is adapted to process a settlement associated with the free message usage certificate purchase request information from each of the affiliated store terminals.

In other words, the free message management server 100 receives the free message usage certificate purchase request information transmitted from each of the affiliated store terminals 300 and transmits the screen interface associated with the settlement of the purchasing price corresponding to the received free message usage certificate purchase request information to the corresponding affiliated store terminal 300 to display it thereon. Subsequently, the free message management server 100 transmits the settlement information inputted from the corresponding affiliated store terminal 300 to the financial company server 500 to request it to settle the corresponding affiliated store's account for the purchasing price. In response to the settlement request, the financial company server 500 settles the corresponding affiliated store's account for the purchasing price and transmits the settlement result to the free message management server 100.

The settlement process by the financial company server 500 can be performed through an online account transfer or credit card settlement, and the settlement-related techniques are well known to those skilled in the art and a detailed description thereof will thus be omitted.

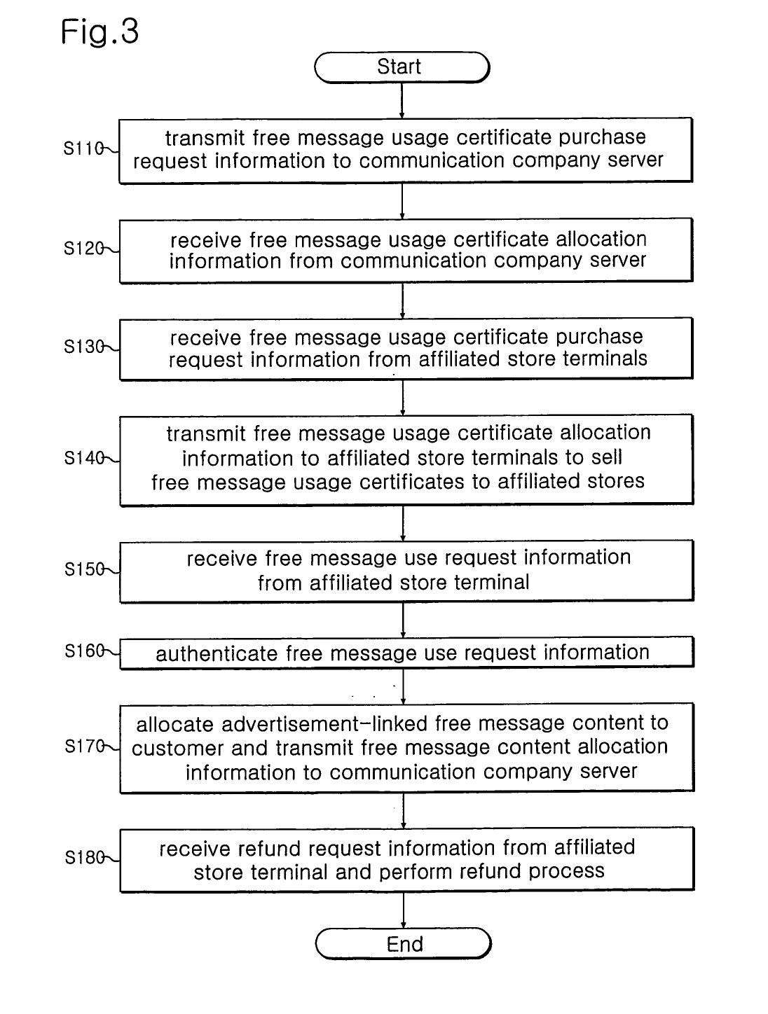

The operation of the embodiment of the advertisement-linked free message provision system with the above-stated configuration according to the present invention will hereinafter be described in detail with reference to FIG. 3.

FIG. 3 is a flow chart illustrating the operation of the embodiment of FIG. 2.

First, at step S110, the free message usage certificate purchase request information transmitter 192 in the free message management server 100 transmits free message usage certificate purchase request information to the communication company server 200.

At step S120, the free message usage certificate allocation information receiver 193 in the free message management server 100 receives free message usage certificate allocation information based on the free message usage certificate purchase request information from the communication company server 200 and stores the received allocation information in the free message usage certificate management database 110.

Provided that the free message management server 100 does not purchase free message usage certificates from the communication company server 200, but issues them by itself in concert with the server 200, it omits the above steps and instead stores information regarding the issuance thereof in the free message usage certificate management database 110.

At step S130, the free message usage certificate purchase request information receiver 161 in the free message management server 100 receives free message usage certificate purchase request information from the affiliated store terminals 300, and the settlement requestor 170 in the free message management server 100 requests the financial company server 500 to settle the corresponding affiliated stores' accounts for free message usage certificate purchasing prices, and then receives results of the settlements from the financial company server 500.

At step S140, the free message usage certificate allocation information transmitter 162 in the free message management server 100 transmits free message usage certificate allocation information based on the free message usage certificate purchase request information received by the free message usage certificate purchase request information receiver 161 respectively to the affiliated store terminals 300 to sell free message usage certificates to the corresponding affiliated stores, and then stores information regarding the sales of the sold free message usage certificates in the free message usage certificate management database 110.

At step S150, the free message use request information receiver 130 in the free message management server 100 receives, from a specific one of the affiliated store terminals 300, free message use request information containing a telephone number of a specific customer acquiring a free message usage certificate and affiliated store identification information.

At step S160, the authentication processor 140 in the free message management server 100 searches the sale information stored in the free message usage certificate management database 110 for sale information corresponding to the affiliated store identification information to determine whether the corresponding sale information is present in the stored sale information, and performs an authentication process based on the determination result.

At step S170, if the free message use request information is authenticated by the authentication processor 140, the free message manager 150 in the free message management server 100 allocates the specific customer a free message content linked to an advertisement of a specific affiliated store holding the specific affiliated store terminal 300 and transmits free message content allocation information containing the telephone number of the specific customer to the communication company server 200 so that the server 200 can deduct the amount of money corresponding to use of the allocated free message content from a text data usage fee to be charged to the customer's telephone number.

At step S180, the refund request information receiver 181 in the free message management server 100 receives refund request information containing a returned amount of the free message usage certificates and the affiliated store identification information from the specific affiliated store terminal 300. If the authentication processor 140 searches the sale information stored in the free message usage certificate management database 110 for the sale information corresponding to the affiliated store identification information to determine whether the corresponding sale information is present in the stored sale information, and authenticates the specific affiliated store as a result of the determination, the refund processor 182 in the free message management server 100 requests the financial company server 500 through the settlement requester 170 to pay the specific affiliated store a refund of the returned free message usage certificate amount contained in the refund request information received by the refund request information receiver 181, and updates the free message usage certificate management database 110 on the basis of the refund request information.

In this manner, in the embodiment of the advertisement-linked free message provision system according to the present invention, a specific customer receives a free message content linked to an advertisement of a specific advertiser, or affiliated store, through a customer terminal and propagates the advertisement of the specific advertiser and free messages to other parties, typically his/her acquaintances, using the received free message content. Therefore, the specific customer can send messages free of charge, and the specific advertiser, or affiliated store, can maximize advertising effects and thus gain an opportunity to win over new customers, which leads to an advanced mobile target marketing advertising activity over an existing one-to-one target marketing advertising activity.

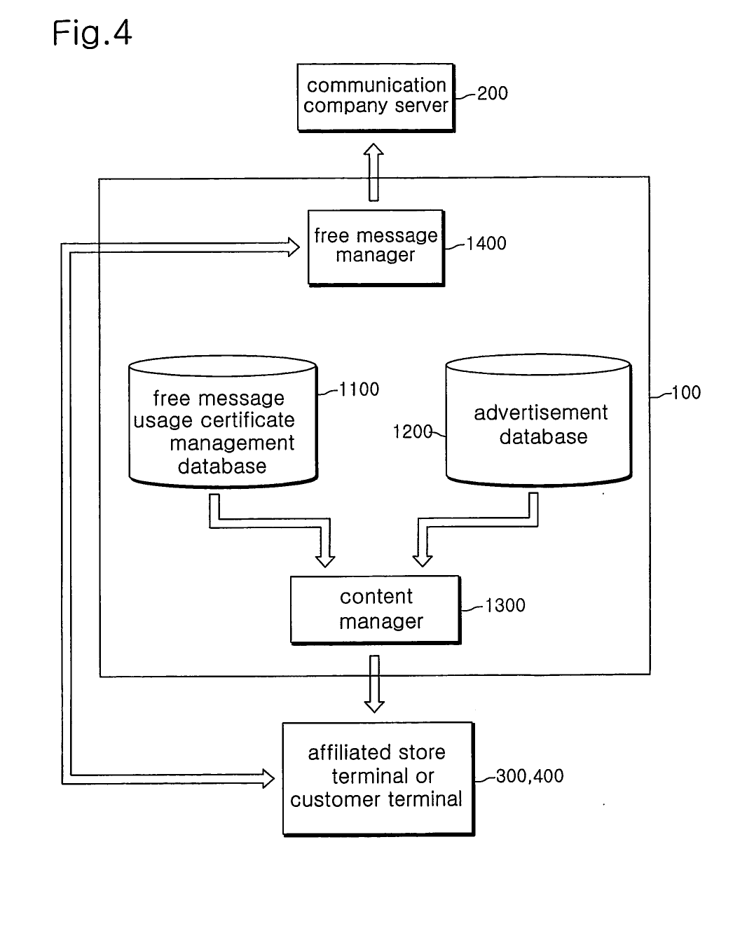

FIG. 4 is a block diagram showing another embodiment of the advertisement-linked free message provision system according to the present invention.

In this embodiment, a free message management server 100 is adapted to distribute free message contents linked respectively to advertisements of respective advertisers, or affiliated stores, to random customer terminals so that the customer terminals can send free messages to other terminals together with the advertisements of the affiliated stores using the distributed free message contents.

With reference to FIG. 4, the free message management server 100 of the advertisement-linked free message provision system includes a free message usage certificate management database 1100, an advertisement database 1200, a content manager 1300, and a free message manager 1400.

The free message usage certificate management database 1100 is adapted to store information regarding the sales of free message usage certificates from at least one communication company, sold to one or more affiliated stores.

The advertisement database 1200 is adapted to store respective advertisements of the affiliated stores.

The content manager 1300 is adapted to create free message contents linked respectively to the advertisements of the affiliated stores stored in the advertisement database 1200 and distribute the created advertisement-linked free message contents.

The free message manager 1400 is adapted to receive information regarding use of a specific one of the distributed advertisement-linked free message contents through a random customer terminal and, on the basis of the received information, request a communication company server 200 to deduct the amount of money corresponding to the use of the specific advertisement-linked free message content from a text data usage fee to be charged to a telephone number of the customer terminal.

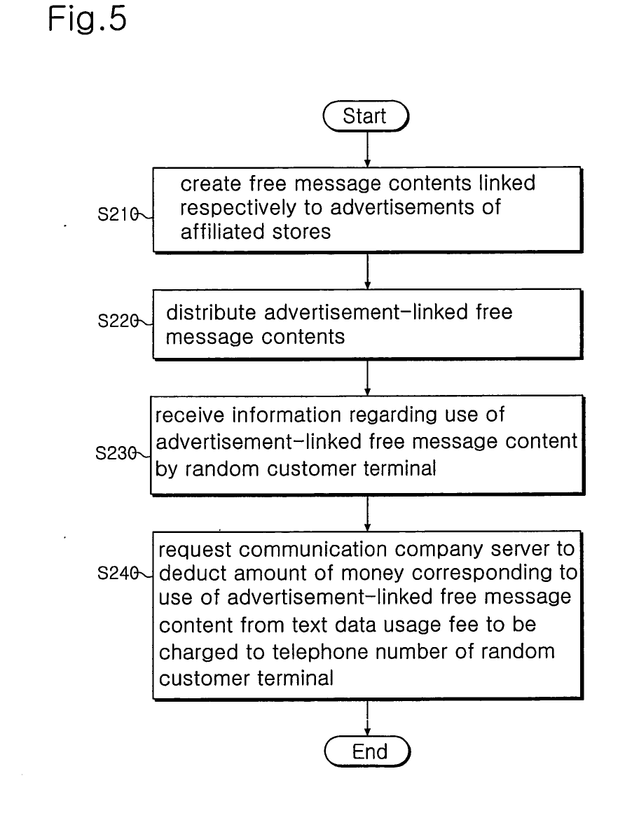

The operation of the second embodiment of the advertisement-linked free message provision system with the above-stated configuration according to the present invention will hereinafter be described in detail with reference to FIG. 5.

First, upon receiving advertisement requests containing advertisements of respective affiliated stores from the corresponding affiliated store terminals 300, the free message management server 100 stores the advertisements of the affiliated stores in the advertisement database 1200, allocates and sells free message usage certificates to the affiliated stores within the range of the remaining amount of free message usage certificates purchased from at least one communication company, and stores information regarding the sales of the free message usage certificates from the communication company, sold to the affiliated stores, in the free message usage certificate management database 1100.

Thereafter, at step S210, the content manager 1300 in the free message management server 100 creates free message contents linked respectively to the advertisements of the affiliated stores stored in the advertisement database 1200.

Then, at step S220, the content manager 1300 in the free message management server 100 distributes the advertisement-linked free message contents created at the above step S210 to random customer terminals.

Alternatively, the content manager 1300 may distribute the advertisement-linked free message contents to the corresponding affiliated store terminals 300 to provide an affiliated store-unit service, as shown in FIG. 2.

Thereafter, at step S230, the free message manager 1400 in the free message management server 100 receives information regarding use of a specific one of the distributed advertisement-linked free message contents by a random customer terminal 400.

Finally, at step S240, the free message manager 1400, on the basis of the received information, requests the communication company server 200 to deduct the amount of money corresponding to the use of the specific advertisement-linked free message content from a text data usage fee to be charged to a telephone number of the random customer terminal 400.

In this manner, in the second embodiment of the advertisement-linked free message provision system according to the present invention, a random customer receives a free message content linked to an advertisement of an advertiser, or affiliated store, through a customer terminal and propagates the advertisement of the advertiser and free messages to other parties, typically his/her acquaintances, using the received free message content. Therefore, the customer can send messages free of charge, and the advertiser, or affiliated store, can maximize advertising effects and thus gain an opportunity to win over new customers, which leads to an advanced mobile target marketing advertising activity over an existing one-to-one target marketing advertising activity.

Meanwhile, in the second embodiment of the advertisement-linked free message provision system shown in FIG. 4, free message usage certificate purchase, settlement and refund processes as described in the first embodiment of FIG. 2 are preferably performed offline although they may be performed online. These processes are implemented in substantially the same manner as those in FIG. 2, and a detailed description and depiction thereof will thus be omitted.

On the other hand, in the second embodiment, each of the advertisement-linked free message contents includes the advertisement of the corresponding affiliated store.

That is, in this case, the specific advertisement-linked free message content including the advertisement of the corresponding affiliated store is transmitted and distributed to the random customer terminal and then stored in a memory thereof. As a result, the random customer terminal can send a free message with contents inputted by the random customer and the advertisement of the affiliated store stored therein to a terminal of another party in an MMS manner.

Alternatively, each of the advertisement-linked free message contents may include information regarding the location of the advertisement of the corresponding affiliated store.

That is, in this case, the specific advertisement-linked free message content including location information of the advertisement of the corresponding affiliated store is transmitted and distributed to the random customer terminal, so there is no need to store the advertisement of the affiliated store in the memory of the customer terminal. As a result, the random customer terminal can send a free message with contents inputted by the random customer and the location information of the advertisement of the affiliated store in an SMS manner to a terminal of another party, which can then receive and display the advertisement of the affiliated store from a location corresponding to the location information.

Therefore, the customer terminal can send an advertisement-linked free message to another party's terminal along with not a large-capacity advertisement, but only location information thereof, thereby preventing a message transfer speed from being reduced.

Meanwhile, in the second embodiment, the content manager 1300 transmits and distributes the specific advertisement-linked free message content to the random customer terminal 400.

That is, in this case, the free message management server 100 creates the specific advertisement-linked free message content and directly distributes the created free message content to the random customer terminal 400.

Alternatively, the content manager 1300 may transmit and distribute the specific advertisement-linked free message content to the corresponding affiliated store terminal 300.

That is, in this case, the free message management server 100 creates the specific advertisement-linked free message content and transmits the created free message content to the corresponding affiliated store terminal 300, which then distributes the transmitted free message content to customers of the corresponding affiliated store. This embodiment is different from the embodiment of FIG. 2 in that it has no authentication process.

Meanwhile, in the second embodiment, each of the advertisement-linked free message contents includes an expiration date.

That is, in this case, the specific advertisement-linked free message content has an expiration date so that the random customer can be forced to use the free message content within the expiration date, thereby increasing advertising effects still more.

Next, a description will be given of an advertisement-linked free message content management module that can be distributed from the free message management server 100 or each affiliated store terminal 300 to the customer terminal 400 and then run in the customer terminal 400.

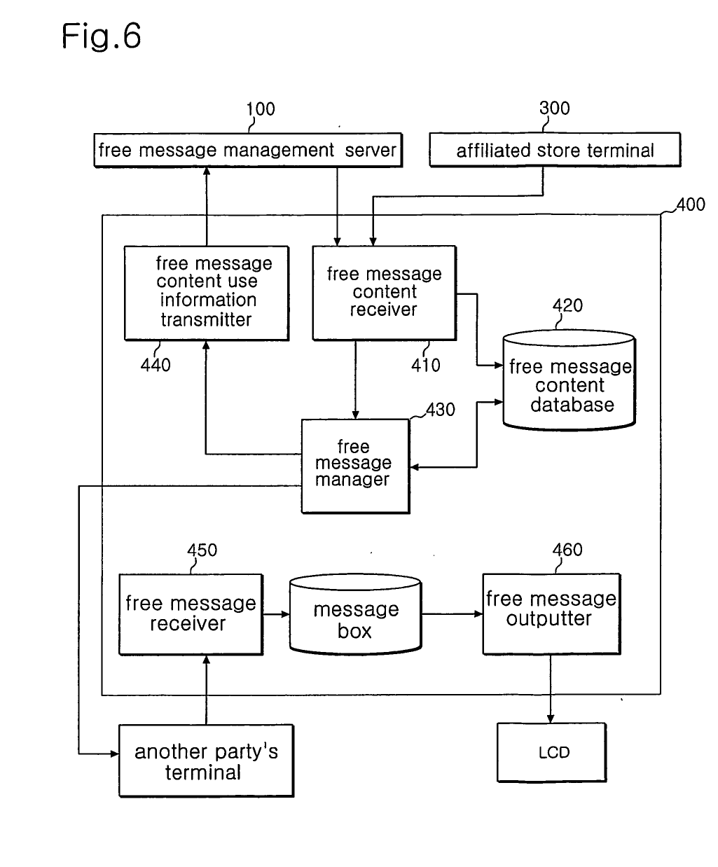

FIG. 6 is a block diagram showing an embodiment of the advertisement-linked free message content management module that can be run in the customer terminal 400.

As shown in FIG. 6, the advertisement-linked free message content management module includes a free message content receiver 410, a free message content database 420, a free message manager 430, and a free message content use information transmitter 440.

The free message content receiver 410 is adapted to receive a free message content linked to an advertisement of a specific affiliated store from the free message management server 100 or the corresponding affiliated store terminal 300 and store the received free message content in the free message content database 420.

In other words, if the free message management server 100 or the affiliated store terminal 300 sends a text message containing access information thereof (for example, a telephone number or uniform resource locator (URL) of the free message management server or affiliated store terminal) to the customer terminal 400 of a user to distribute an advertisement-linked free message content thereto, then the user gains access to the free message management server 100 or the affiliated store terminal 300 using the access information to request it to download the advertisement-linked free message content.

Then, the free message content receiver 410 of the advertisement-linked free message content management module, which is implemented in the form of software that can be run in the customer terminal 400, receives the advertisement-linked free message content from the free message management server 100 or the affiliated store terminal 300 and stores the received free message content in the free message content database 420.

The free message manager 430 is adapted to execute the advertisement-linked free message content stored in the free message content database 420, receive message contents and a telephone number of a message recipient inputted from the user and send an advertisement-linked free message with the received contents to the message recipient's telephone number.

In other words, if the user executes the distributed advertisement-linked free message content through the free message manager 430 (for example, by selecting a corresponding menu of the customer terminal) to send a free message to a mobile communication terminal of another party, or a message recipient, free of charge using the advertisement-linked free message content, then the free message content requests the user to input message contents and a telephone number of the message recipient. Thereafter, if the message contents and the message recipient's telephone number are inputted by the user, then the free message manager 430 sends an advertisement and the inputted message contents to the inputted telephone number in an SMS or MMS manner.

The free message content use information transmitter 440 is adapted to transmit information regarding the use of the free message content through the free message manager 430 by the user to the free message management server 100.

The advertisement-linked free message content management module that can be run in the customer terminal 400, configured as stated above, is operated in the below manner.

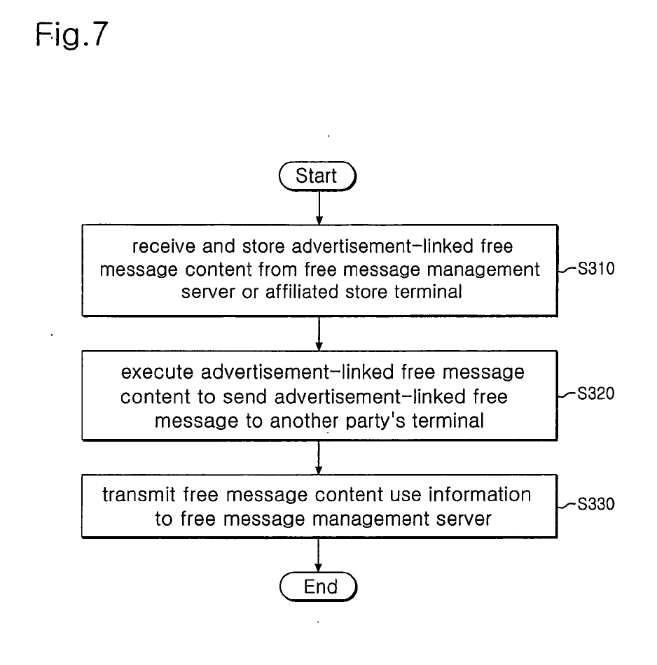

FIG. 7 is a flow chart illustrating the operation of the advertisement-linked free message content management module of FIG. 6.

First, at step S310, the free message content receiver 410 receives a free message content linked to an advertisement of a specific affiliated store from the free message management server 100 or the corresponding affiliated store terminal 300 and stores the received free message content in the free message content database 420.

In order to send a free message to another party's terminal using the customer terminal 400, the user executes the advertisement-linked free message content stored in the free message content database 420 through the free message manager 430 at step S320. Then, the free message manager 430 receives message contents and a message recipient's telephone number inputted from the user and sends an advertisement-linked free message with the inputted contents to the recipient's telephone number.

Finally, at step S330, the free message content use information transmitter 440 transmits information regarding the use of the advertisement-linked free message content by the user to the free message management server 100.

Hence, a customer can send a message free of charge using an advertisement-linked free message content distributed from an affiliated store, and the affiliated store can propagate an advertisement thereof.

Meanwhile, in the present embodiment, the advertisement-linked free message content management module that can be run in the customer terminal 400 further includes a free message receiver 450, and a free message outputter 460.

The free message receiver 450 is adapted to receive an advertisement-linked free message sent from a different customer terminal.

The free message outputter 460 is adapted to output the free message received by the free message receiver 450 to a screen of the customer terminal 400.

Therefore, the advertisement-linked free message content management module runnable in the customer terminal 400 can receive an advertisement-linked free message sent from a different customer terminal through the free message receiver 450 and output the received free message to a liquid crystal display (LCD) of the customer terminal 400 through the free message outputter 460, so as to display message contents and an advertisement sent from the different customer terminal.

On the other hand, in the present embodiment, the advertisement-linked free message content includes the advertisement of the specific affiliated store.

In this case, the customer terminal 400 stores, in a memory thereof, the advertisement of the specific affiliated store included in the advertisement-linked free message content received by the free message content receiver 410, and reads it from the memory for sending of a free message to another party's terminal. As a result, the user can send a free message with contents inputted thereby and the advertisement of the specific affiliated store stored in the customer terminal 400 to a terminal of another party in an MMS manner.

Alternatively, the advertisement-linked free message content may include information regarding the location of the advertisement of the specific affiliated store.

The free message outputter 460 receives an advertisement from location information contained in the received free message and outputs the received advertisement to the screen along with the received free message.

Therefore, because the advertisement-linked free message content received by the free message content receiver 410 includes only the location information of the advertisement of the specific affiliated store, the customer terminal 400 sends a free message with contents inputted by the user and the location information of the advertisement of the specific affiliated store in an SMS manner to a terminal of another party, which then receives and displays the advertisement of the specific affiliated store from a location corresponding to the location information. Consequently, the customer terminal 400 sends an advertisement-linked free message to another party's terminal along with not a large-capacity advertisement, but only location information thereof, thereby preventing a message transfer speed from being reduced.

Meanwhile, in the present embodiment, the free message content use information transmitter 440 may check the number of messages set in the advertisement-linked free message content, and transmit the free message content use information to the free message management server 100 if the user has sent all the set number of messages.

In other words, as the user sends an advertisement-linked free message to another party's terminal by executing the advertisement-linked free message content through the free message manager 430, the free message content use information transmitter 440 generates information regarding the use of the free message content.

For example, provided that a free message content allowing sending of one hundred free messages have been distributed to the user, the free message content use information transmitter 440 transmits free message content use information containing a count for each message sending, to the free message management server 100 whenever each of the hundred free messages is sent or when all of them have been sent.

Thus, the free message management server 100 can recognize information regarding the use of the advertisement-linked free message content through the customer terminal 400 and request the communication company server 200 to deduct the amount of money corresponding to the use of the free message content from a data usage fee to be charged to the customer terminal's telephone number. Therefore, a customer can send messages free of charge, and an advertiser, or affiliated store, can gain an opportunity to win over new customers, which leads to an advanced mobile target marketing advertising activity over an existing one-to-one target marketing advertising activity.

Meanwhile, in the present embodiment, the advertisement-linked free message content may include an expiration date.

That is, the advertisement-linked free message content has an expiration date so that the user can be forced to use the free message content within the expiration date, thereby increasing advertising effects still more.

Preferably, the advertisement includes at least one of a video, image and text.

In this manner, in the present embodiment, a customer receives a free message content linked to an advertisement of an advertiser, or affiliated store, through a customer terminal and propagates the advertisement of the advertiser and free messages to other parties, typically his/her acquaintances, using the received free message content. Therefore, the customer can send messages free of charge, and the advertiser, or affiliated store, can maximize advertising effects and thus gain an opportunity to win over new customers, which leads to an advanced mobile target marketing advertising activity over an existing one-to-one target marketing advertising activity.

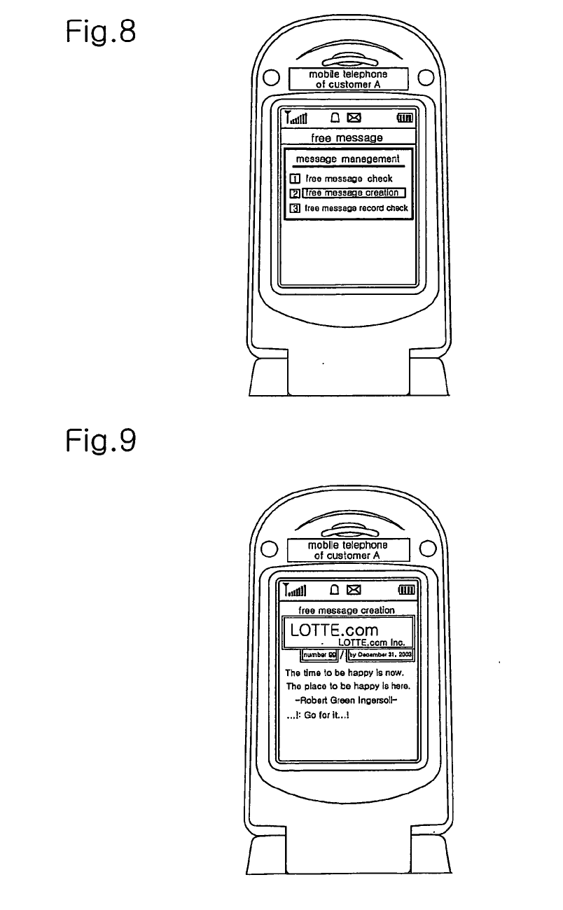

FIGS. 8 to 11 are views showing exemplary screens of an advertisement-linked free message content which is executed in the customer terminal 400.

FIG. 8 shows a screen of a free message management menu of the advertisement-linked free message content, and FIG. 9 shows a message input screen with its top portion linked to an affiliated store's advertisement.

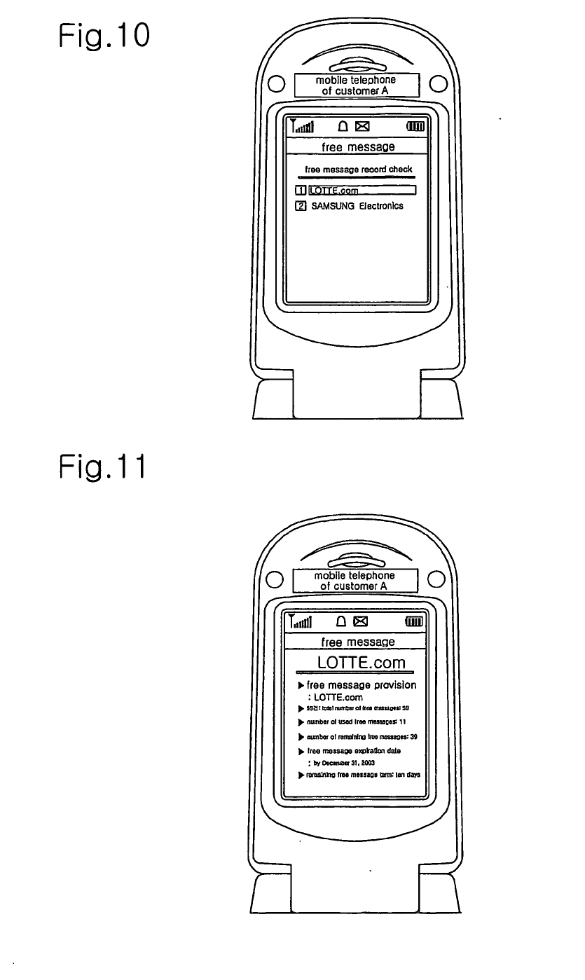

FIG. 10 shows a check selection menu screen for records of advertisement-linked free messages sent from the customer terminal 400, and FIG. 11 shows a record check menu screen.

Furthermore, the advertisement-linked free message provision system can provide a free message service linked to differential advertisements based on various advertising techniques, for example, ages, sexes, occupations, residence places, consumption types, consumption propensities, etc. of VIP customers of each affiliated store, through mobile communication terminals usually carried by the customers, such as mobile telephones or PDAS, and propagate the advertisements to preliminary VIP customers through the existing VIP customers using the free message service, so as to maximize advertising effects.

In this manner, the advertisement-linked free message provision system according to the present invention can accomplish the above-presented objects.

### INDUSTRIAL APPLICABILITY

As apparent from the above description, the present invention provides an advertisement-linked free message provision system wherein each affiliated store distributes free message usage certificates linked to an advertisement thereof to customers for the purpose of advertising itself, thereby reducing the customers' burdens of text data usage fees to enable the customers to use a message service without a heavy burden. Further, each affiliated store can maximize advertising effects through a free message service linked to the advertisement thereof. A communication company can fixedly sell free message usage certificates in large quantities, so as to increase sales and secure stable earnings. A free message usage certificate service provider can purchase the free message usage certificates from the communication company in large quantities at low price and resell them at higher price, so as to obtain resale profits.

In other words, in the advertisement-linked free message provision system according to the present invention, a customer receives a free message content linked to an advertisement of an advertiser, or affiliated store, through a customer terminal and propagates the advertisement of the advertiser and free messages to other parties, typically his/her acquaintances, using the received free message content. Therefore, the customer can send messages free of charge, and the advertiser, or affiliated store, can maximize advertising effects and thus gain an opportunity to win over new customers, which leads to an advanced mobile target marketing advertising activity over an existing one-to-one target marketing advertising activity.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An advertisement-linked free message provision system in which a message sender sends an advertisement-linked free message to a message recipient, comprising a free message management server including:
a free message usage certificate management database for storing information regarding sales of free message usage certificates from at least one communication company, sold to one or more affiliated stores;
an advertisement database for storing advertisements;
a free message use request information receiver for receiving free message use request information containing a telephone number of a specific customer acquiring at least one of the free message usage certificates and affiliated store identification information from a specific one of one or more affiliated store terminals held respectively by the affiliated stores;
an authentication processor for searching the sale information stored in the free message usage certificate management database for sale information corresponding to the affiliated store identification information to determine whether the corresponding sale information is present in the stored sale information, and performing an authentication process based on the determination result; and
a free message manager for, if the free message use request information is authenticated by the authentication processor, allocating an advertisement-linked free message content to the specific customer and transmitting free message content allocation information containing the telephone number of the specific customer to a communication company server managed by the communication company so that the communication company server can deduct the amount of money corresponding to use of the allocated free message content from a text data usage fee to be charged to the customer's telephone number.

2. The advertisement-linked free message provision system as set forth in claim 1, wherein the free message management server further includes:
a free message usage certificate purchase request information receiver for receiving free message usage certificate purchase request information from each of the affiliated store terminals; and
a free message usage certificate allocation information transmitter for transmitting free message usage certificate allocation information based on the free message usage certificate purchase request information received by the free message usage certificate purchase request information receiver to each of the affiliated store terminals.

3. The advertisement-linked free message provision system as set forth in claim 2, wherein the free message management server further includes a settlement requestor for transmitting settlement request information to at least one financial company server to request it to settle the affiliated stores' accounts for prices for purchases of the free message usage certificates, respectively, and then receiving results of the settlements from the financial company server.

4. The advertisement-linked free message provision system as set forth in claim 3, wherein the free message management server further includes:
a refund request information receiver for receiving refund request information containing a returned amount of the free message usage certificates and the affiliated store identification information from the specific affiliated store terminal; and
a refund processor for, if the authentication processor searches the sale information stored in the free message usage certificate management database for the sale information corresponding to the affiliated store identification information to determine whether the corresponding sale information is present in the stored sale information, and authenticates a specific one of the affiliated stores holding the specific affiliated store terminal as a result of the determination, requesting the financial company server through the settlement requester to pay the specific affiliated store a refund of the returned free message usage certificate amount contained in the refund request information received by the refund request information receiver, and updating the free message usage certificate management database on the basis of the refund request information.

5. The advertisement-linked free message provision system as set forth in claim 4, wherein the free message management server further includes an affiliated store advertisement receiver for receiving respective advertisements of the affiliated stores from the affiliated store terminals and storing the received advertisements in the advertisement database.

6. The advertisement-linked free message provision system as set forth in claim 5, wherein:
the advertisement-linked free message content allocated to the specific customer is a free message content linked to the advertisement of the specific affiliated store; and
the free message manager is adapted to check whether the specific customer has sent all messages of a number set in the allocated free message content, and request the communication company server to deduct the amount of money corresponding to the use of the allocated free message content from the text data usage fee to be charged to the specific customer's telephone number, if the specific customer has sent all the set number of messages.

7. The advertisement-linked free message provision system as set forth in claim 6, wherein the free message management server further includes:
a free message usage certificate purchase request information transmitter for transmitting free message usage certificate purchase request information to the communication company server; and
a free message usage certificate allocation information receiver for receiving free message usage certificate allocation information based on the free message usage certificate purchase request information from the communication company server.

8. The advertisement-linked free message provision system as set forth in any one of claims 1 to 7, further comprising the communication company server adapted for allocating the free message usage certificates to the free message management server and, on the basis of the free message content allocation information from the free message management server, deducting the amount of money corresponding to the use of the allocated advertisement-linked free message content from the text data usage fee to be charged to the specific customer's telephone number contained in the free message content allocation information.

9. The advertisement-linked free message provision system as set forth in claim 8, further comprising the one or more affiliated store terminals, each adapted for transmitting free message use request information containing a telephone number of a customer acquiring at least one of the free message usage certificates and affiliated store identification information for authentication to the free message management server.

10. The advertisement-linked free message provision system as set forth in claim 9, wherein each of the affiliated store terminals is further adapted to transmit the free message usage certificate purchase request information to the free message management server and receive the free message usage certificate allocation information based on the free message usage certificate purchase request information from the free message management server.

11. The advertisement-linked free message provision system as set forth in claim 9, further comprising the at least one financial company server adapted for processing a settlement associated with the free message usage certificate purchase request information from each of the affiliated store terminals.

12. The advertisement-linked free message provision system as set forth in claim 11, further comprising at least one customer terminal for receiving the advertisement-linked free message content allocated from the free message management server and using a short message service (SMS) or multimedia message service (MMS) free of charge using the received free message content.

13. An advertisement-linked free message provision system comprising a free message management server including:
a free message usage certificate management database for storing information regarding sales of free message usage certificates from at least one communication company, sold to one or more affiliated stores;
an advertisement database for storing respective advertisements of the affiliated stores;
a content manager for creating free message contents linked respectively to the advertisements of the affiliated stores stored in the advertisement database and distributing the created advertisement-linked free message contents; and
a free message manager for receiving information regarding use of a specific one of the distributed advertisement-linked free message contents through a random customer terminal and, on the basis of the received information, requesting the communication company to deduct the amount of money corresponding to the use of the specific advertisement-linked free message content from a text data usage fee to be charged to a telephone number of the customer terminal.

14. The advertisement-linked free message provision system as set forth in claim 13, wherein each of the advertisement-linked free message contents includes the advertisement of a corresponding one of the affiliated stores.

15. The advertisement-linked free message provision system as set forth in claim 13, wherein each of the advertisement-linked free message contents includes information regarding a location of the advertisement of a corresponding one of the affiliated stores.

16. The advertisement-linked free message provision system as set forth in claim 13, wherein the content manager is adapted to transmit and distribute the advertisement-linked free message contents to customer terminals.

17. The advertisement-linked free message provision system as set forth in claim 13, wherein the content manager is adapted to transmit and distribute each of the advertisement-linked free message contents to a corresponding one of one or more affiliated store terminals held respectively by the affiliated stores.

18. The advertisement-linked free message provision system as set forth in any one of claims 14 to 17, wherein each of the advertisement-linked free message contents includes an expiration date.

19. A mobile communication terminal comprising:
a free message content receiver for receiving a free message content linked to an advertisement of a specific affiliated store from a free message management server or an affiliated store terminal held by the specific affiliated store and storing the received free message content in a free message content database;
a free message manager for executing the advertisement-linked free message content stored in the free message content database, receiving message contents and a telephone number of a message recipient inputted from a user, and sending a free message linked to the advertisement of the specific affiliated store and containing the received contents to the message recipient's telephone number; and
a free message content use information transmitter for transmitting information regarding use of the free message content through the free message manager by the user to the free message management server.

20. The mobile communication terminal as set forth in claim 19, further comprising:
a free message receiver for receiving an advertisement-linked free message sent from a different mobile communication terminal; and
a free message outputter for outputting the free message received by the free message receiver to a screen of the mobile communication terminal.

21. The mobile communication terminal as set forth in claim 19 or 20, wherein the advertisement-linked free message content includes the advertisement of the specific affiliated store.

22. The mobile communication terminal as set forth in claim 19 or 20, wherein the advertisement-linked free message content includes information regarding a location of the advertisement of the specific affiliated store.

23. The mobile communication terminal as set forth in claim 19 or 20, wherein the free message content use information transmitter is adapted to check the number of messages set in the advertisement-linked free message content, and transmit the free message content use information to the free message management server if the user has sent all the set number of messages.

24. The mobile communication terminal as set forth in claim 19 or 20, wherein the advertisement-linked free message content includes an expiration date.

25. The mobile communication terminal as set forth in claim 22, wherein the free message outputter is adapted to receive an advertisement from location information contained in the received free message and output the received advertisement to the screen along with the received free message.

26. The mobile communication terminal as set forth in claim 19 or 20, wherein the advertisement of the specific affiliated store includes at least one of a video, image and text.
